(19) United States
(12) Patent Application Publication
(10) Pub. No.: US 2023/0004348 A1
(43) Pub. Date: Jan. 5, 2023

(54) Methods and Apparatus for Efficient Denormal Handling In Floating-Point Units

(71) Applicant: Huawei Technologies Co., Ltd., Shenzhen (CN)

(72) Inventor: Michael Thomas Dibrino, Austin, TX (US)

(21) Appl. No.: 17/940,394

(22) Filed: Sep. 8, 2022

Related U.S. Application Data
(63) Continuation of application No. PCT/US2020/053055, filed on Sep. 28, 2020.
(60) Provisional application No. 63/032,602, filed on May 30, 2020.

(51) Int. Cl. G06F 7/483

(52) U.S. Cl. CPC G06F 7/483

(57) ABSTRACT

A floating-point (FP) arithmetic unit includes a first FP execution pipeline operatively coupled to a register file, the first FP execution pipeline configured to perform a first FP operation on a first FP operand provided by the register file, the first FP execution pipeline comprising a plurality of execution units; and a first normalization unit operatively coupled to the register file, and the first FP execution pipeline, the first normalization unit configured to normalize the first FP operand, wherein the first normalization unit is configured to operate in parallel with the first FP execution pipeline, and is further configured to, in response to detecting that the first FP operand is a denormal, assert a first FP execution pipeline busy flag to stall the instruction dispatch of a first subsequent FP operation, the first FP operation and the first subsequent FP operation being of one FP operation type.

### CROSS-REFERENCE TO RELATED APPLICATIONS

This application is a continuation of International Application PCT/US2020/053055, filed Sep. 28, 2020, entitled “Methods and Apparatus for Efficient Denormal Handling in Floating-Point Units,” which claims the benefit of U.S. Provisional Application No. 63/032,602, filed on May 30, 2020, entitled “Efficient Denormal Handling in Superscalar Floating-Point Units,” which applications of which are incorporated herein by reference in their entireties.

### TECHNICAL FIELD

The present disclosure relates generally to methods and apparatus for digital computing, and, in particular embodiments, to methods and apparatus for efficient denormal handling in floating-point units.

### BACKGROUND

Denormals are floating-point values in the IEEE-754 floating-point standard in which the leading bit ahead of the fraction is assumed to be ‘0’ instead of a ‘1’. They are indicated by an exponent field of zero and a fraction field of non-zero. A true zero is indicated by an exponent field of zero and a fraction field also of zero.

There are two cases involving denormals which must be handled by floating-point execution units: input denormals and output denormals. Input denormals are denormals which appear at the input of the execution units and must be processed by the execution units. Output denormals are denormals which are produced by the execution units as a result of an arithmetic computation and may be written into the register files, stored into memory, or forwarded back to the inputs of the execution units.

### SUMMARY

According to a first aspect, a floating-point (FP) arithmetic unit is provided. The FP arithmetic unit includes: a first FP execution pipeline operatively coupled to a register file and an instruction dispatch, the first FP execution pipeline configured to perform a first FP operation on a first FP operand provided by the register file, the first FP execution pipeline comprising a plurality of execution units; and a first normalization unit operatively coupled to the register file, the first FP execution pipeline, and the instruction dispatch, the first normalization unit configured to normalize the first FP operand provided by the register file, wherein the first normalization unit is configured to operate in parallel with the first FP execution pipeline, and is further configured to, in response to detecting that the first FP operand is a denormal, assert a first FP execution pipeline busy flag to stall the instruction dispatch of a first subsequent FP operation and to provide the normalized first FP operand to the first FP execution pipeline, the first FP operation and the first subsequent FP operation being of one FP operation type.

In a first implementation form of the FP arithmetic unit according to the first aspect, wherein the first FP execution pipeline is further configured to perform a second FP operation on a second FP operand provided by the register file; wherein the first normalization unit is further configured to normalize the second FP operand provided by the register file; and wherein in response to detecting that the second FP operand is normal, the first normalization unit is configured to discard the normalized second FP operand.

In a second implementation form of the FP arithmetic unit according to the first aspect or any preceding implementation form of the first aspect, wherein the FP execution pipeline comprises one of a FP addition execution pipeline, a FP multiplication pipeline, an FP division pipeline, an FP square-root or generalized root pipeline, an FP exponential pipeline, an FP power pipeline, or an FP logarithm pipeline, or any other operation or instruction on a floating-point operand.

In a third implementation form of the FP arithmetic unit according to the first aspect or any preceding implementation form of the first aspect, further comprising: a second FP execution pipeline operatively coupled to the register file and the instruction dispatch, the second FP execution pipeline configured to perform a third FP operation on a third FP operand provided by the register file, the second FP execution pipeline comprising a plurality of execution units; and a second normalization unit operatively coupled to the register file, the second FP execution pipeline, and the instruction dispatch, the second normalization unit configured to normalize the third FP operand provided by the register file, wherein the second normalization unit is configured to operate in parallel with the second FP execution pipeline, and is configured to, in response to detecting that the third FP operand is a denormal, assert a second FP execution pipeline busy flag to stall the instruction dispatch of a second subsequent FP operation and to provide the normalized third FP operand to the second FP execution pipeline, the third FP operation and the second subsequent FP operation being of one FP operation type.

In a fourth implementation form of the FP arithmetic unit according to the first aspect or any preceding implementation form of the first aspect, wherein the second FP execution pipeline is further configured to perform a fourth FP operation on a fourth FP operand provided by the register file; wherein the second normalization unit is further configured to normalize the fourth FP operand provided by the register file; and wherein in response to detecting that the fourth FP operand is a normal, the second normalization unit is configured to discard the normalized fourth FP operand.

In a fifth implementation form of the FP arithmetic unit according to the first aspect or any preceding implementation form of the first aspect, wherein the first normalization unit is further configured to cause the second normalization unit to assert the second FP execution pipeline busy flag and to provide the normalized third FP operand to the second FP execution pipeline when asserting the first FP execution pipeline busy flag, and wherein the second normalization unit is further configured to cause the first normalization unit to assert the first FP execution pipeline busy flag and to provide the normalized first FP operand to the first FP execution pipeline when asserting the second FP execution pipeline busy flag.

In a sixth implementation form of the FP arithmetic unit according to the first aspect or any preceding implementation form of the first aspect, further comprising a denormal unit operatively coupled to the first FP execution pipeline, the denormal unit configured to convert a fifth FP operand outputted by the first FP execution pipeline into a denormal.

According to a second aspect, a system is provided. The system comprising: a non-transitory memory storage comprising instructions and data; one or more processors in communication with the memory storage, wherein the one or more processors execute the instructions; and a FP arithmetic unit in communication with the one or more processors and the memory storage, the FP arithmetic unit comprising: a first FP execution pipeline operatively coupled to a register file and an instruction dispatch, the first FP execution pipeline configured to perform a first FP operation on a first FP operand provided by the register file, the first FP execution pipeline comprising a plurality of execution units; and a first normalization unit operatively coupled to the register file, the first FP execution pipeline, and the instruction dispatch, the first normalization unit configured to normalize the first FP operand provided by the register file, wherein the first normalization unit is configured to operate in parallel with the first FP execution pipeline, and is configured to, in response to detecting that the first FP operand is a denormal, assert a first FP execution pipeline busy flag to stall the instruction dispatch of a first subsequent FP operation and to provide the normalized first FP operand to the first FP execution pipeline, the first FP operation and the first subsequent FP operation being of one FP operation type.

In a first implementation form of the system according to the second aspect, wherein the first FP execution pipeline is further configured to perform a second FP operation on a second FP operand provided by the register file; wherein the first normalization unit is further configured to normalize the second FP operand provided by the register file; and wherein in response to detecting that the second FP operand is a normal, the first normalization unit is configured to discard the normalized second FP operand.

In a second implementation form of the system according to the second aspect or any preceding implementation form of the second aspect, wherein the FP execution pipeline comprises one of a FP addition execution pipeline, a FP multiplication pipeline, an FP division pipeline, an FP square-root or generalized root pipeline, an FP exponential pipeline, an FP power pipeline, or an FP logarithm pipeline, or any other operation or instruction on a floating-point operand.

In a third implementation form of the system according to the second aspect or any preceding implementation form of the second aspect, further comprising: a second FP execution pipeline operatively coupled to the register file and the instruction dispatch, the second FP execution pipeline configured to perform a third FP operation on a third FP operand provided by the register file, the second FP execution pipeline comprising a plurality of execution units; and a second normalization unit operatively coupled to the register file, the second FP execution pipeline, and the instruction dispatch, the second normalization unit configured to normalize the third FP operand provided by the register file, wherein the second normalization unit is configured to operate in parallel with the second FP execution pipeline, and is further configured to, in response to detecting that the third FP operand is a denormal, assert a second FP execution pipeline busy flag to stall the instruction dispatch of a second subsequent FP operation and to provide the normalized third FP operand to the second FP execution pipeline, the third FP operation and the second subsequent FP operation being of one FP operation type.

In a fourth implementation form of the system according to the second aspect or any preceding implementation form of the second aspect, wherein the second FP execution pipeline is further configured to perform a fourth FP operation on a fourth FP operand provided by the register file; wherein the second normalization unit is further configured to normalize the fourth FP operand provided by the register file; and wherein in response to detecting that the fourth FP operand is a normal, the second normalization unit is configured to discard the normalized fourth FP operand.

In a fifth implementation form of the system according to the second aspect or any preceding implementation form of the second aspect, wherein the first normalization unit is further configured to cause the second normalization unit to assert the second FP execution pipeline busy flag and to provide the normalized third FP operand to the second FP execution pipeline when asserting the first FP execution pipeline busy flag, and wherein the second normalization unit is further configured to cause the first normalization unit to assert the first FP execution pipeline busy flag and to provide the normalized first FP operand to the first FP execution pipeline when asserting the second FP execution pipeline busy flag.

In a sixth implementation form of the system according to the second aspect or any preceding implementation form of the second aspect, further comprising a denormal unit operatively coupled to the first FP execution pipeline, the denormal unit configured to convert a fifth FP operand outputted by the first FP execution pipeline into a denormal.

According to a third aspect, a method implemented by a FP arithmetic unit is provided. The method comprising: receiving, by the FP arithmetic unit, from an instruction dispatch, a first FP operation and a first FP operand; executing, by a first FP execution pipeline of the FP arithmetic unit, the first FP operation with the first FP operand; normalizing, by a first normalization unit of the FP arithmetic unit, the first FP operand in parallel with the executing of the first FP operation; and detecting, by the first normalization unit of the FP arithmetic unit, that the first FP operand is a denormal, and based thereon, asserting, by the first normalization unit of the FP arithmetic unit, a first FP execution pipeline busy flag to stall the instruction dispatch of a first subsequent FP operation, the first FP operation and the first subsequent FP operation being of one FP operation type; and providing, by the first normalization unit of the FP arithmetic unit, the normalized first FP operand to the first FP execution pipeline.

In a first implementation form of the method according to the third aspect, further comprising: receiving, by the FP arithmetic unit, from the instruction dispatch, a second FP operation and a second FP operand; executing, by the first FP execution pipeline of the FP arithmetic unit, the second FP operation with the second FP operand; normalizing, by the first normalization unit of the FP arithmetic unit, the second FP operand in parallel with the executing of the second FP operation; and detecting, by the first normalization unit of the FP arithmetic unit, that the first FP operand is a normal, and based thereon, discarding the normalized second FP operand.

In a second implementation form of the method according to the third aspect or any preceding implementation form of the third aspect, further comprising: receiving, by the FP arithmetic unit, from the instruction dispatch, a third FP operation and a third FP operand; executing, by a second FP execution pipeline of the FP arithmetic unit, the third FP operation with the third FP operand; normalizing, by a second normalization unit of the FP arithmetic unit, the third FP operand in parallel with the executing of the third FP operation; and detecting, by the second normalization unit of the FP arithmetic unit, that the third FP operand is a denormal, and based thereon, asserting, by the second normalization unit of the FP arithmetic unit, a second FP execution pipeline busy flag to stall the instruction dispatch of a second subsequent FP operation, the third FP operation and the second subsequent FP operation being of one FP operation type; and providing, by the second normalization unit of the FP arithmetic unit, the normalized second FP operand to the second FP execution pipeline.

In a third implementation form of the method according to the third aspect or any preceding implementation form of the third aspect, further comprising: receiving, by the FP arithmetic unit, from the instruction dispatch, a fourth FP operation and a fourth FP operand; executing, by the second FP execution pipeline of the FP arithmetic unit, the fourth FP operation with the fourth FP operand; normalizing, by the second normalization unit of the FP arithmetic unit, the fourth FP operand in parallel with the executing of the fourth FP operation; and detecting, by the second normalization unit of the FP arithmetic unit, that the fourth FP operand is a normal, and based thereon, discarding the normalized fourth FP operand.

In a fourth implementation form of the method according to the third aspect or any preceding implementation form of the third aspect, further comprising, when detecting that the first FP operand is a denormal: asserting, by the second normalization unit of the FP arithmetic unit, the second FP execution pipeline busy flag to stall the instruction dispatch of a subsequent FP operating having the same FP operation type as the third FP operation; and providing, by the second normalization unit of the FP arithmetic unit, the normalized second FP operand to the second FP execution pipeline.

In a fifth implementation form of the method according to the third aspect or any preceding implementation form of the third aspect, further comprising converting, by a denormal unit of the FP arithmetic unit, a sixth FP operand outputted by the first FP execution pipeline to the denormal FP number unit.

In a sixth implementation form of the method according to the third aspect or any preceding implementation form of the third aspect, the first FP operation comprising one of a FP addition operation or a FP multiplication operation.

In a seventh implementation form of the method according to the third aspect or any preceding implementation form of the third aspect, the first subsequent FP operation and the first FP operation are of the same operation type.

An advantage of a preferred embodiment is that the processing of operands of a FP operation is performed in parallel. Therefore, additional processing associated with denormals is incurred only when at least one of the operands of the FP operation is a denormal. If none of the operands are denormals, then processing associated with denormal processing is not incurred.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1A illustrates a single precision floating-point number in the IEEE 754 format;

FIG. 1B illustrates a double precision floating-point number in the IEEE 754 format;

FIG. 2 illustrates a number range of values representable by a single precision floating-point number in the IEEE 754 standard;

FIG. 3 illustrates a prior art floating-point arithmetic unit;

FIG. 4 illustrates an example floating-point arithmetic unit according to example embodiments presented herein;

FIGS. 5A-5F illustrate a sequence of floating-point arithmetic unit block diagrams highlighting the execution of a first example sequence of floating-point instructions with some denormal operands according to example embodiments presented herein;

FIGS. 6A-6I illustrate a sequence of floating-point arithmetic unit block diagrams highlighting the execution of a second example sequence of floating-point instructions with some denormal operands according to example embodiments presented herein;

FIG. 7 illustrates a flow diagram of example operations occurring in a floating-point arithmetic unit that is capable of processing denormal inputs without incurring additional latency associated with the processing of denormals according to example embodiments presented herein; and

FIG. 8 illustrates a block diagram of a computing system that may include the methods and apparatus disclosed herein.

### DETAILED DESCRIPTION OF ILLUSTRATIVE EMBODIMENTS

The structure and use of disclosed embodiments are discussed in detail below. It should be appreciated, however, that the present disclosure provides many applicable concepts that can be embodied in a wide variety of specific contexts. The specific embodiments discussed are merely illustrative of specific structure and use of embodiments, and do not limit the scope of the disclosure.

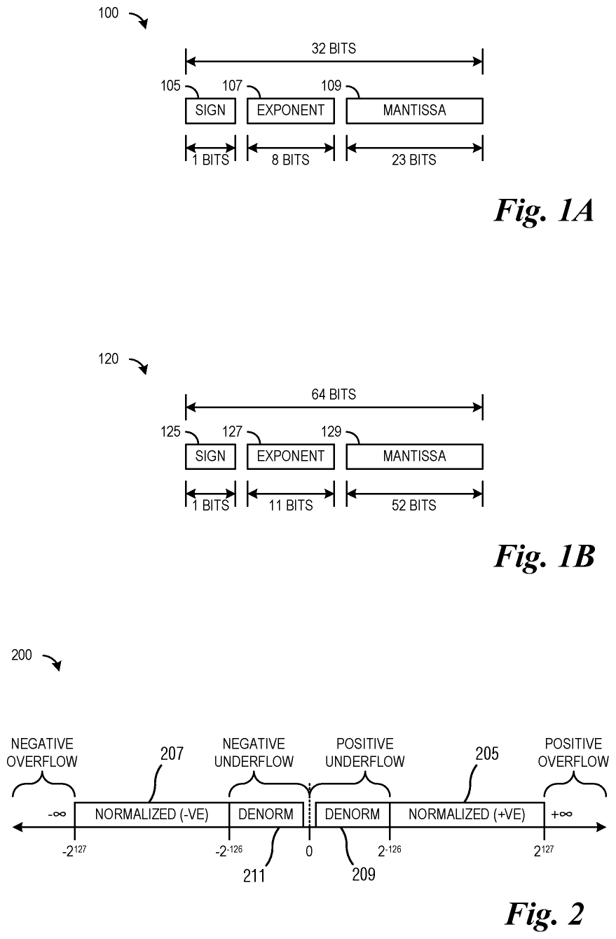

FIG. 1A illustrates a single precision floating-point number 100 in the IEEE 754 format. Single precision floating-point number 100 is 32 bits long with a 1-bit sign 105, an 8-bit exponent 107, and a 23-bit mantissa 109. There is an implicit ‘1’ as the leading bit of mantissa 109 when the floating-point number is normal. FIG. 1B illustrates a double precision floating-point number 120 in the IEEE 754 format. Double precision floating point number 120 is 64 bits long with a 1-bit sign 125, an 11-bit exponent 127, and a 52-bit mantissa 129, with an implicit ‘1’ as the leading bit of mantissa 129 when the floating-point number is a normal. A smallest value representable with single precision floating-point number 100 is +/−2⁻¹²⁶. For double precision floating-point number 150, the smallest representable value is +/−2⁻¹⁰²².

Denormals are floating-point values where the leading bit of the mantissa is assumed to be a ‘0’ rather than a ‘1’. In the IEEE 754 standard, denormals are indicated by a zero in the exponent field and a non-zero mantissa field. The value of a denormal is expressible as:

(−1)^{S}(0·M)2⁻¹²⁶(single precision)

(−1)^{S}(0·M)2⁻¹⁰²²(double precision)

where S is the value of the sign field, and M is the value of the mantissa field. The IEEE 754 standard uses denormals to fill in the gap between zero and the smallest normalized floating-point number. The denormals are also used to provide a gradual underflow to zero.

FIG. 2 illustrates a number range 200 of values representable by a single precision floating-point number in the IEEE 754 standard. As shown in FIG. 2, using normalized values, the range of positive values is from +2⁻¹²⁶ to +2¹²⁷ (shown as range 205) and the range of negative values is from −2¹²⁷ to −2⁻¹²⁶ (shown as range 207). A positive overflow situation occurs with any positive number greater than +2¹²⁷. Similarly, any negative number lesser than −2¹²⁷ results in a negative overflow situation.

Denormals represent some of the values that are more positive than zero but less than the smallest values representable by normalized floating-point values (shown as range 209 for positive values and range 211 for negative values). Underflow is said to occur when the exact result of an operation is nonzero, but with an absolute value that is smaller than the smallest normalized floating point number. Therefore, denormals represent values in positive underflow (a floating point number in range 209) and negative underflow (a floating point number in range 211) conditions.

A superscalar processor leverages instruction level parallelism to allow more work to be performed at the same clock rate. A superscalar processor executes more than one instruction at the same time by having multiple floating-point execution units, with each floating-point execution unit potentially be pipelined. A pipelined floating-point execution unit includes multiple stages that each performs a fraction of the work of the floating-point execution unit in totality. As an example, in a pipelined floating-point execution unit with three stages, an instruction to be executed in the floating-point execution unit is broken into three tasks with each task being associated with one of the three stages. In order for the instruction to complete, all three stages of the pipeline have to complete. As one stage completes its task, and provides information the next stage in the pipeline. However, instead of becoming idle, the stage that just completed is provided with a new task from a new instruction and remains busy by executing the new task. Therefore, multiple instructions may be executed in a single clock cycle. Hence, computational performance is improved.

The handling of denormals requires more processing than typical normal floating-point numbers. Typically, a denormal would be normalized, which involves detecting the leading zeros and removing the leading zeros, prior to undergoing the processing of the typical normal floating-point number. The normalization process usually requires a combination of leading zeros counting and left-shifting of the mantissa. Furthermore, the exponent must be adjusted by the leading zeros count, implying the inclusion of an adder in the exponent path.

There are two conditions where a floating-point functional unit (a functional unit designed to operate on floating-point numbers) has to handle when it comes to denormals:
Input denormals—denormals that are at the input of the floating-point functional unit and must be processed by the stages in the floating-point functional unit.
Output denormals—denormals that are produced by the stages as a result of an arithmetic computation (e.g., subtraction of two floating-point values that are almost equal to one another) and may be written to register files, stored in memory, or forward back to inputs of the stages.

Prior art techniques exist for handling input denormals. They include:
Forcing all denormal inputs to software routines that will provide needed processing. This is referred to as traps. However, software routines are extremely slow compared to hardware solutions.
Stalling the dispatch of instructions with denormal input so that normalization can take place. A prenormalization stall may be introduced, which prevents the instruction dispatcher from dispatching instructions, resulting in a significant performance slowdown.
Providing support for gross underflow situations in hardware but force other underflow situations to software. However, software routines are extremely slow compared to hardware solutions. Also, hardware support for gross underflow situations may be complex, add latency, and be difficult to verify.
Always normalize all inputs in the execution pipeline. The performance of the float-point execution pipeline is penalized for all floating-point operations, even those without denormal inputs.
Modifying the arithmetic units of the floating-point execution pipelines to natively handle all denormals. Again, the delay associated with the floating-point execution pipelines is increased, leading to lower clock rates. Furthermore, the complexity of the floating-point execution pipelines is increased, leading to greater difficulty in functional verification.

Prior art techniques also exist for handling output denormals. They include:
Stalling the floating-point execution pipelines (i.e., a back-end stall). Significant impact on latency is incurred.
Adding a right shift register at the end of the floating-point execution pipelines as an output denormalizer. Significant impact on latency is incurred.
Sending the result (of the floating-point operation) to another unit of the pipeline for denormalization or feedback to the same floating-point execution pipelines for denormalization. Significant impact on latency is incurred.
Preventing output denormals, e.g., with a leading zero anticipator (LZA) mask.
   Although this technique can handle output denormals with less latency than the previous prior-art approaches, if the output denormal is forwarded to another floating-point execution pipeline for immediate use, the output denormal (now an input denormal in another floating-point execution pipeline) will require input normalization.

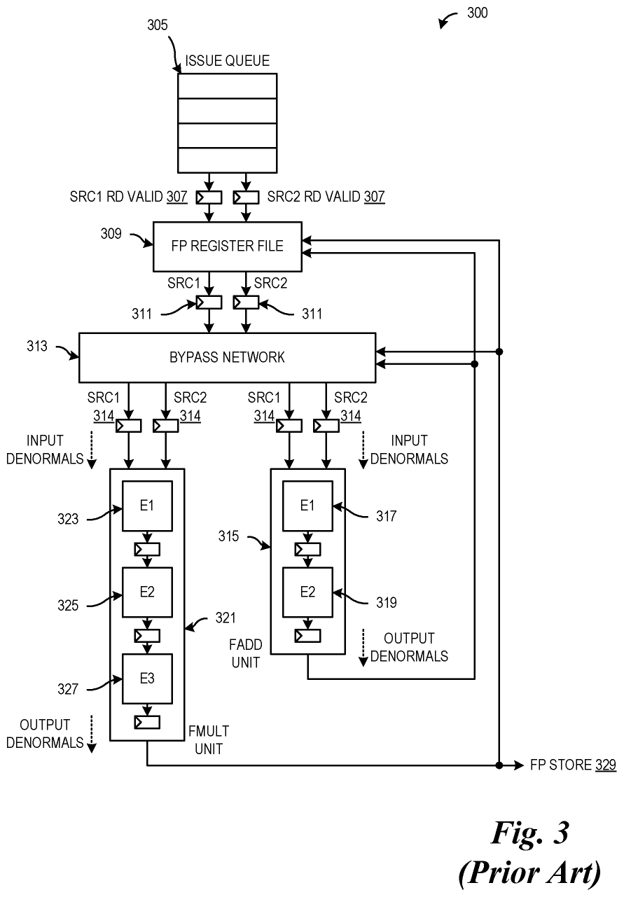

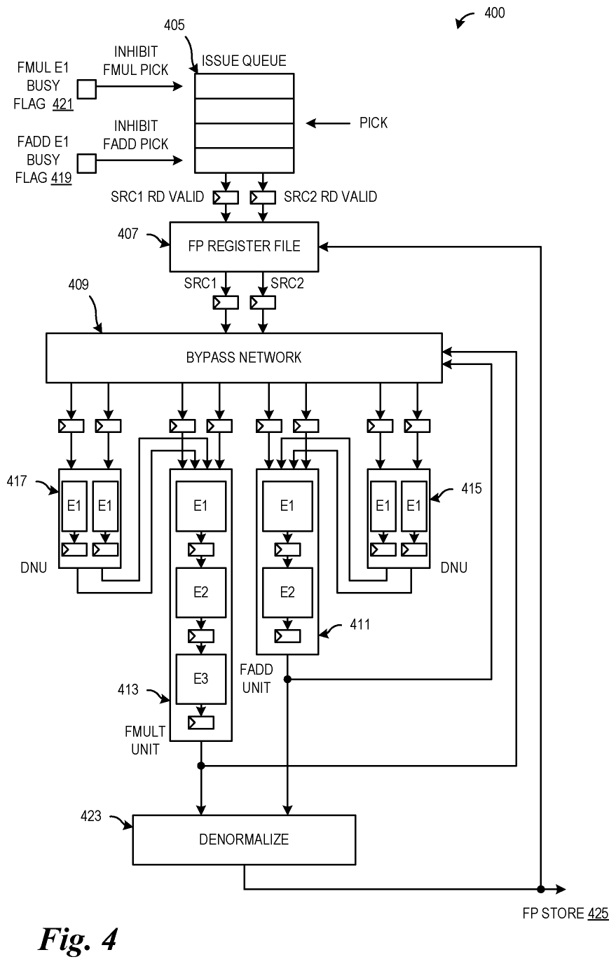

FIG. 3 illustrates a prior art floating-point arithmetic unit 300. Floating-point arithmetic unit 300 includes an instruction issue queue 305 that stores instructions for subsequent execution. Instruction issue queue 305 may enable out of order execution, where instructions may be executed in a different order from how they are stored in instruction issue queue 305. The order of execution may be dependent upon data dependencies, for example. Operands of the instructions may be provided to a floating-point register file 309, which stores the operands before or after execution. Depending on the instruction being executed, contents of registers of floating-point register file 309 are provided to a bypass network 313, which allows the operands to be provided to a floating-point execution pipeline corresponding to the instruction being executed.

As shown in FIG. 3, floating-point arithmetic unit 300 includes two floating-point execution pipelines, a floating point addition pipeline 315 and a floating point multiply pipeline 321. Other implementations of floating-point arithmetic unit 300 may have different numbers of floating-point execution pipelines.

As shown in FIG. 3, floating-point addition pipeline 315 includes two pipelined stages 317 and 319, while floating-point multiply pipeline 321 includes three pipelined stages 323, 325, and 327. Output of pipelines 315 and 321 are written back to floating-point register file 309. Output of pipelines 315 and 321 may also be forwarded to bypass network 313 if the output is used immediately for other instructions. Furthermore, the outputs of pipeline 315 and 321 may be stored to memory through a floating-point store pipeline 329 if the output is not immediately used for other instructions.

Registers (such as registers 307, 311, and 314, as well as registers between stages of pipelines 315 and 321) may be used to synchronize the operation of the various components of floating-point arithmetic unit 300 to a clock.

As shown in FIG. 3, if input denormals are provided to pipelines 315 or 321, pipelines 315 or 321 may use any of the prior art techniques discussed above for handling the input denormals before pipelines 315 and 321 processes the floating-point input. Similarly, if output denormals are output by pipelines 315 or 321, pipelines 315 or 321 may use any of the prior art techniques discussed above for handling the output denormals before outputting the output denormals to floating-point store pipeline 329, floating-point register file 309, or bypass network 313.

According to an example embodiment, methods and apparatus are provided that enable the computation of arithmetic operations with denormal inputs in a floating-point execution pipeline of a floating-point arithmetic unit without incurring additional pipeline latency associated with the processing of the denormals to the processing of normal floating-point operands. If denormal values are rarely encountered in well-written code, the floating-point execution pipelines should not be designed such that they incur additional latency due to denormal normalization. Doing so would penalize the most commonly occurring cases to handle a small number of rarely encountered cases. As an example, denormal normalization typically consumes ⅓ to ½ of a clock cycle for the leading zero detection and left-shift operations (for up to 53 bits in the double-precision floating-point format). Therefore, adding denormal normalization to floating-point execution pipelines may result in a one clock-cycle penalty (due to the addition of an additional pipeline stage dedicated to denormal normalization). In a two-stage floating-point execution pipeline, this will lead to a 50% penalty, while a three-stage floating-point execution pipeline incurs a 33% penalty.

According to an example embodiment, the denormal normalization operation is performed in a pipeline dedicated to normalization of denormals that executes in parallel to the floating-point execution pipeline used for processing normal floating-point operands. The normalized denormals (normalized in the parallel pipeline) are then rescheduled and take place of the denormals in the normal floating-point execution pipeline (which have not yet been executed), completing the processing of the operands.

In an embodiment, in a situation where a floating-point operation involves at least one denormal operand, the issuing of a subsequent floating-point operation of the same operation type (e.g., a floating-point add if the floating-point operation involving a denormal operand is a floating-point add, a floating-point multiply if the floating-point operation involving a denormal operand is a floating-point multiply, etc.) for the next clock cycle is blocked. Other types of floating-point operations may include floating-point divide, floating-point square-root or generalized root, floating-point exponential, floating-point power, floating-point logarithm, and so on. Although the discussion focusses on floating-point addition and floating-point multiplication operations, the example embodiments presented herein are operable with any floating-point operation type. Therefore, the focus on floating-point addition and multiplication should not be construed as being limiting to the scope of the example embodiments.

However, if the floating-point arithmetic unit has multiple floating-point execution pipelines configured to process the same type of floating-point operation, then it may not be necessary to block the subsequent floating-point operation if there is one or more floating-point execution pipelines is not currently processing a floating-point operation involving a denormal operand. As an example, if the floating-point arithmetic unit includes two floating-point add pipelines, and a first of the floating-point add pipelines is processing a floating-point add with a denormal operand, it is not necessary to block a subsequent floating-point add in the next clock cycle as long a second of the floating-point add pipelines is not also processing a floating-point add.

In an embodiment, first stage of each floating-point execution pipeline operates under an assumption that all of the input operands are normal floating-point values. This applies to floating-point execution pipelines that are serviced by an issue queue.

In an embodiment, the denormal normalization operation is performed in parallel to a first stage of all floating-point execution pipelines in the floating-point arithmetic unit. The unit performing denormal normalization, referred to herein as a denormal normalization unit (DNU), is configured to normalize each source operand that is a denormal.

In an embodiment, in a situation if all source operands of a floating-point operation are normal, the results of the DNU are ignored. Instead, the second stage of the floating-point execution pipeline (and subsequent stages if present) operates on the input operands as processed by the first stage of the floating-point execution pipeline. Therefore, no additional latency is incurred for normal operands.

In an embodiment, in situations where at least one of the operands of the floating-point execution pipeline is a denormal, the DNU, dedicated to normalizing denormals, normalizes the denormal operand(s). While, occurring in parallel, the first stage of floating-point execution pipeline processes the operands as if the operands are in the normal floating-point format (although at least one of the operands is a denormal). Then, once the DNU completes the normalization processing, the normalized operand(s) are provided to the floating-point execution pipeline.

In an embodiment, the output of the DNU is provided to the first stage of the floating-point execution pipeline, where the operands (now normalized) are processed as if the operands had never been denormals.

In an embodiment, to prevent a floating-point operation of the same type from being issued and colliding with the processing of the normalized operands, a flag (or status bit) is asserted to a specified value to block the issue of a subsequent floating-point operation of the same floating-point operation type to the floating-point execution pipeline. The flag (or status bit) may be implemented using a single bit. As an example, the flag (or status bit) is set to a binary ‘1’ to block the issue of the subsequent floating-point operation of the same type to the floating-point execution pipeline. The reverse value (i.e., a binary ‘0’) may alternatively be used to block the issue of the subsequent floating-point operation. A multi-bit flag or indicator may be used in place of the flag or status bit.

In an embodiment, the flag (or status bit) is set to the specified value for only one clock cycle to block the issue of the subsequent floating-point operation of the same type to the floating-point execution pipeline for one clock cycle. After which time, the flag (or status bit) may be cleared.

As discussed previously, in a situation where the floating-point arithmetic unit has multiple floating-point execution pipelines configured to process the same floating-point operation of a single type, only the flag (or status bit) associated with the floating-point execution pipeline that received the denormal operand is asserted. In other words, each floating-point execution pipeline has its own flag (or status bit) and they are independently controlled and set or reset as needed.

In an embodiment, the processing of the denormal source operand(s) performed by the first stage of the floating-point execution pipeline that occurred in parallel to the processing performed by the DNU is discarded. Because the floating-point execution pipeline processed the operands as if they were in normal floating-point format (although at least one of the operands was a denormal), the results may be incorrect. Therefore, any results produced by the first stage of the floating-point execution pipeline are discarded.

In an embodiment, as related to output denormals, output denormals are generated only when results are to be written back to the floating-point register file or the floating-point store. If the output of the floating-point execution pipeline is immediately used for another floating-point operation, the output is retained in an intermediate floating-point format to prevent the need to normalize denormals in a subsequent operation. Latency in a floating-point execution pipeline is saved by never generating output denormals (i.e., denormalizing floating-point values) prior to forwarding. Instead, output denormals are generated only during register writebacks or floating-point stores.

FIG. 4 illustrates an example floating-point arithmetic unit 400. Floating-point arithmetic unit 400 includes an instruction issue queue 405 that stores instructions for subsequent execution. Instruction issue queue 405 may enable out of order execution, where instructions may be executed in a different order from how they are stored in instruction issue queue 405. The order of execution may be dependent upon data dependencies, for example. Operands of the instructions may be provided to a floating-point register file 407, which stores the operands before or after execution. Depending on the instruction being executed, contents of registers of floating-point register file 407 are provided to a bypass network 409, which allows the operands to be provided to a floating-point execution pipeline corresponding to the instruction being executed.

Floating-point arithmetic unit 400 includes two floating-point execution pipelines, a floating-point add pipeline 411 and a floating-point multiply pipeline 413. Although floating-point arithmetic unit 400 is shown with two floating-point execution pipelines, other implementations of floating-point arithmetic unit 400 may have different numbers of floating-point execution pipelines. As an example, an alternate implementation of floating-point arithmetic unit 400 includes three floating-point execution units, each implementing a different floating-point operation. As another example, an alternate implementation of floating-point arithmetic unit 400 includes multiple copies of the same floating-point execution unit (as an example, two floating-point add units and two floating-point multiply units). Other combinations of floating-point units, floating-point operation types, and numbers of floating-point execution units are possible.

As shown in FIG. 4, floating-point add pipeline 411 includes two pipelined stages, while floating-point multiply pipeline 413 includes three pipelined stages. Other numbers of pipelined stages are possible.

Floating-point arithmetic unit 400 also includes DNUs 415 and 417, one DNU for each floating-point execution pipeline. DNU 415 is associated with floating-point add pipeline 411 and DNU 417 is associated with floating-point multiply pipeline 413. As shown in FIG. 4, a DNU and its associated floating-point execution pipeline are provided the same operands. As an example, floating-point add pipeline 411 and DNU 415 are provided the same operands, and floating-point multiply pipeline 413 and DNU 415 are provided the same operands.

DNUs 415 and 417 each includes a single stage that performs denormal normalization of operands provided by bypass network. As discussed previously, the DNUs operate in parallel with their associated floating-point execution pipeline, and perform denormal normalization on the provided operands. The DNUs may perform denormal normalization on the provided operands irrespective of the operands being denormals or not. If none of the operands provided to a DNU are denormals, the results of the denormal normalization are discarded, and the floating-point execution pipeline associated with the DNU proceeds with its processing of the provided operands (which are the same as the operands provided to the DNU) as usual.

If at least one of the operands provided to a DNU is a denormal, the normalized operands are provided to the first stage of the associated floating-point execution pipeline and the associated floating-point execution pipeline processes the normalized operands as if the operands were provided by bypass network 409. An example operation of a DNU is as follows:
In parallel to the associated floating-point execution pipeline, the DNU checks each operand and normalizes each denormal operand.
If all operands are normal, then the results of the DNU are not used. Instead, the second stage (and any subsequent stage) processes the operands as provided by bypass network 409.
If any operand is denormal,
   A pipeline valid bit from the first stage of the associated floating-point execution pipeline and the second stage of the associated floating-point execution pipeline is set to indicate that the pipeline is not valid and halt propagation of the results of the first stage.
   All denormal operands are normalized by the DNU and forwarded to the first stage of the associated floating-point execution pipeline.
   A flag (or status bit) 419 or 421 associated with the DNU is set to indicate to issue queue 405 to stall the issue of a floating-point operation of the same operation type as the one associated with the DNU. As shown in FIG. 4, floating-point add busy flag (FADD E1 BUSY FLAG) 419 is associated with DNU 415, while floating-point multiply busy flag (FMUL E1 BUSY FLAG) 421 is associated with DNU 417. Hence, if FADD E1 BUSY FLAG 419 is set to the specified value, issue queue 405 will stall floating-point add operations. Similarly, if FMUL E1 BUSY FLAG 421 is set to the specified value, issue queue 405 will stall floating-point multiply operations. As an example, the flag (or status bit) is set to stall the issue of a floating-point operation of the same operation type as the one associated with the DNU.

In an embodiment, floating-point arithmetic unit 400 also includes a denormalize unit 423. Denormalize unit 423 is configured to convert a normalized floating-point value in an intermediate or extended exponent format into a denormal, provided that the normalized floating-point value is representable as a denormal and does not underflow to zero. Denormalize unit 423 receives as input, floating-point values from the floating-point execution pipelines and denormalizes any floating-point value meeting the underflow condition when the floating-point value is to be written back to floating-point register file 407 or floating-point store 425.

However, outputs of the floating-point execution pipelines, if immediately being used in a subsequent floating-point operations and not being written back to floating-point register file 409 or floating-point store 425, are provided to bypass network 409 without being denormalized (even if they meet the underflow condition). Hence, latency associated with denormalizing floating-point values is saved.

In an embodiment, floating-point exceptions, such as overflow, underflow, etc., are set as necessary during denormalization and writebacks to floating-point register file 407 or floating point store 425.

In an embodiment, in order to prevent having to normalize denormals or denormalize floating-point values that meet the underflow condition, an intermediate representation of floating-point values with greater precision is used in bypass network 409 and floating-point execution pipelines. As an example, the floating-point execution pipelines and bypass network 409 operate on normalized data with exponents in an extended exponent format. The extended exponent format is a format in which the exponent field is extended by at least one bit. As an example, the most significant bit (MSB) of the exponent is replaced by n bits: [E_{MSB}, ˜E_{MSB}, . . . , ˜E_{MSB}].

Floating-point arithmetic unit 400, as shown in FIG. 4, presents an example implementation of a floating-point arithmetic unit according to the example embodiments presented herein. Other configurations are possible. As an example, an alternative floating-point arithmetic unit may have a floating-point execution pipeline configured to perform rounding operations, division operations, square-root or generalized root operations, exponential operations, power operations, logarithm operations, etc. As another example, an alternative floating-point arithmetic unit may have more than one floating-point execution pipeline configured to perform the same operation, e.g., two floating-point add pipelines and one floating-point multiply pipeline. Other values and configurations are possible.

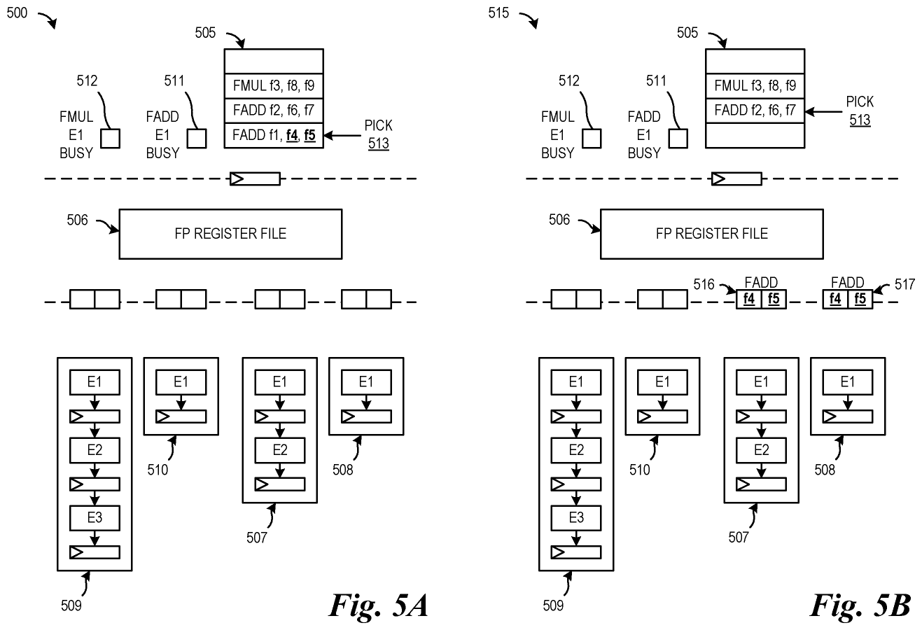

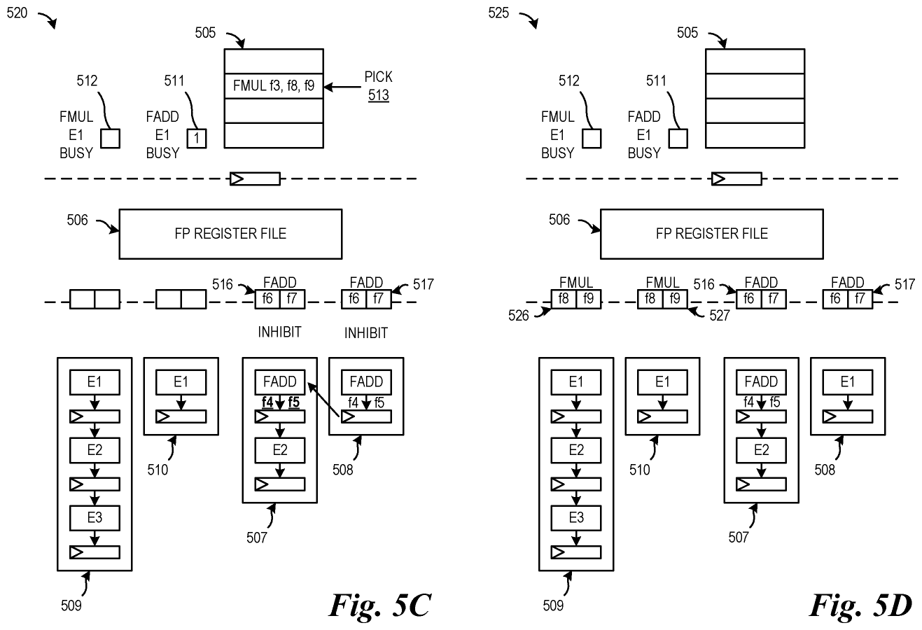

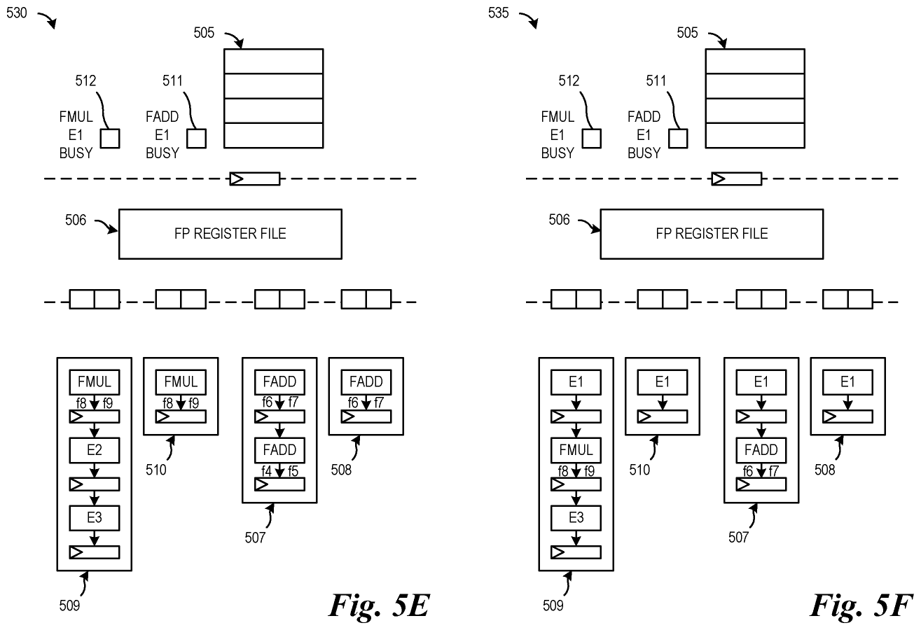

FIGS. 5A-5F illustrate a sequence of floating-point arithmetic unit block diagrams highlighting the execution of a first example sequence of floating-point instructions with some denormal operands.

FIG. 5A illustrates a first floating-point arithmetic unit block diagram 500. First floating-point arithmetic unit block diagram 500 displays a floating-point arithmetic unit with an issue queue 505, a floating-point register file 506, a floating-point add pipeline 507, a first DNU 508 that is associated with floating-point add pipeline 507, a floating-point multiply pipeline 509, a second DNU 510 that is associated with floating-point multiply pipeline 509, a floating-point add busy flag 511, a floating-point multiply busy flag 512, and a pick 513 pointing to a next floating-point instruction to be dispatched. As shown in FIG. 5A, no floating-point instructions have been dispatched. However, pick 513 is pointing at floating-point instruction “FADD f1, f4, f5” with both operands f4 and f5 being bolded and underlined to indicate that operands f4 and f5 being denormals.

FIG. 5B illustrates a second floating-point arithmetic unit block diagram 515. Second floating-point arithmetic unit block diagram 515 displays the floating-point arithmetic unit one clock cycle after first floating-point arithmetic unit block diagram 500 shown in FIG. 5A. After one clock cycle, floating-point instruction “FADD f1, f4, f5” has been issued and operands have been loaded into registers 516 and 517 for loading into the first stages of floating-point add pipeline 507 and first DNU 508. Also, pick 513 has now moved to floating-point instruction “FADD f2, f6, f7” with both operands f6 and f7 being normal floating-point values.

FIG. 5C illustrates a third floating-point arithmetic unit block diagram 520. Third floating-point arithmetic unit block diagram 520 displays the floating-point arithmetic unit one clock cycle after second floating-point arithmetic unit block diagram 515 shown in FIG. 5B. After one clock cycle, the first stage of floating-point add pipeline 507 has processed operands f4 and f5 (although they were denormals). Also, first DNU 508 has normalized operands f4 and f5. Because operands f4 and f5 were denormals, floating-point add busy flag 511 was set to the specified value to stall issue queue 505 from issuing floating-point add operations. FADD E1 Busy flag 511 being set now blocks the transfer of floating-point operands f6 and f7 in register 516 into the first stages of floating-point pipeline 507. Instead, outputs of first DNU 508 (the normalized operands f4 and f5) are provided to the first stage of floating-point add pipeline 507. Pick 513 has now moved to floating-point instruction “FMUL f3, f8, f9” with both operands f8 and f9 being normal floating-point values.

FIG. 5D illustrates a fourth floating-point arithmetic unit block diagram 525. Fourth floating-point arithmetic unit block diagram 525 displays the floating-point arithmetic unit one clock cycle after third floating-point arithmetic unit block diagram 520 shown in FIG. 5C. After one clock cycle, the first stage of floating-point add pipeline 507 has processed normalized operands f4 and f5. Additionally, floating-point add busy flag 511 has been cleared and it therefore no longer inhibits operands f6 and f7 from being provided to the first stages of floating-point add pipeline 507 and first DNU 508 in the next clock cycle. Similarly, memories 526 and 527 hold operands f8 and f9 of floating-point instruction “FMUL f3, f8, f9”.

FIG. 5E illustrates a fifth floating-point arithmetic unit block diagram 530. Fifth floating-point arithmetic unit block diagram 530 displays floating-point arithmetic unit one clock cycle after fourth floating-point arithmetic unit block diagram 525 shown in FIG. 5D. After one clock cycle, the second stage of floating-point add pipeline 507 has processed the output of the first stage of floating-point add pipeline 507. The first stage of floating-point add pipeline 507 has processed operands f6 and f7. Because operands f6 and f7 are normals, the processing of first DNU 508 are not utilized. Additionally, the first stage of floating-point multiply pipeline 509 has processed operands f8 and f9. Because operands f8 and f9 are normals, the processing of second DNU 510 are not utilized.

FIG. 5F illustrates a sixth floating-point arithmetic unit block diagram 535. Sixth floating-point arithmetic unit block diagram 535 displays floating-point arithmetic unit one clock cycle after fifth floating-point arithmetic block diagram 530 shown in FIG. 5E. After one clock cycle, the second stage of floating-point add pipeline 507 has processed the output of the first stage of floating-point add pipeline 507. The second stage of the floating-point multiply pipeline 509 has processed the output of the first stage of the floating-point multiply pipeline 509. Additional processing may occur in subsequent clock cycles, but are not shown herein.

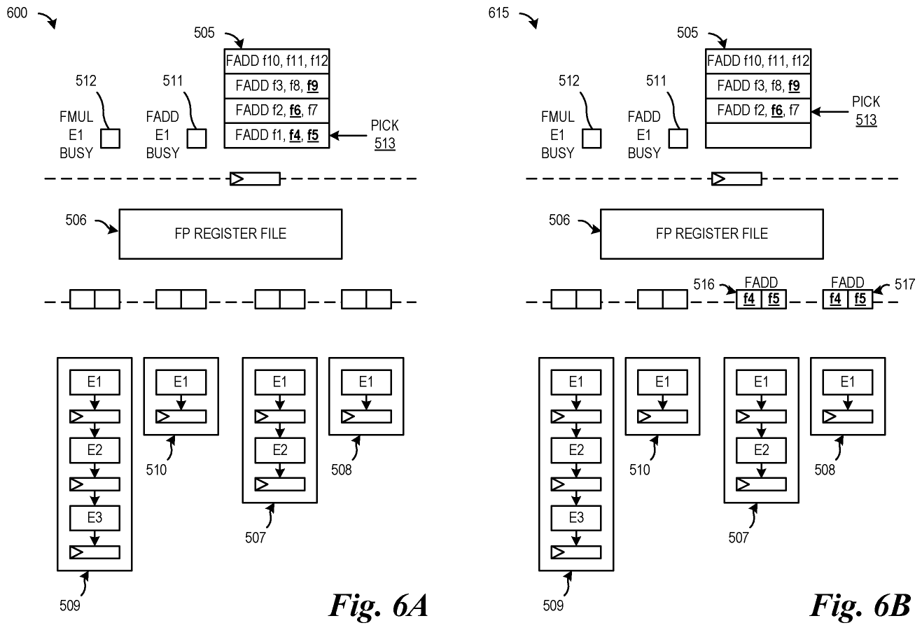

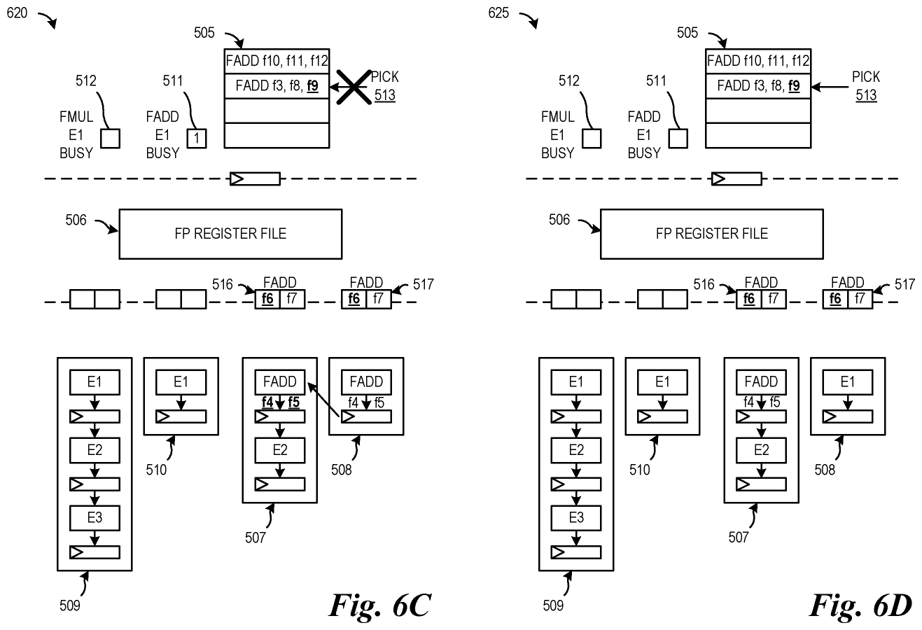

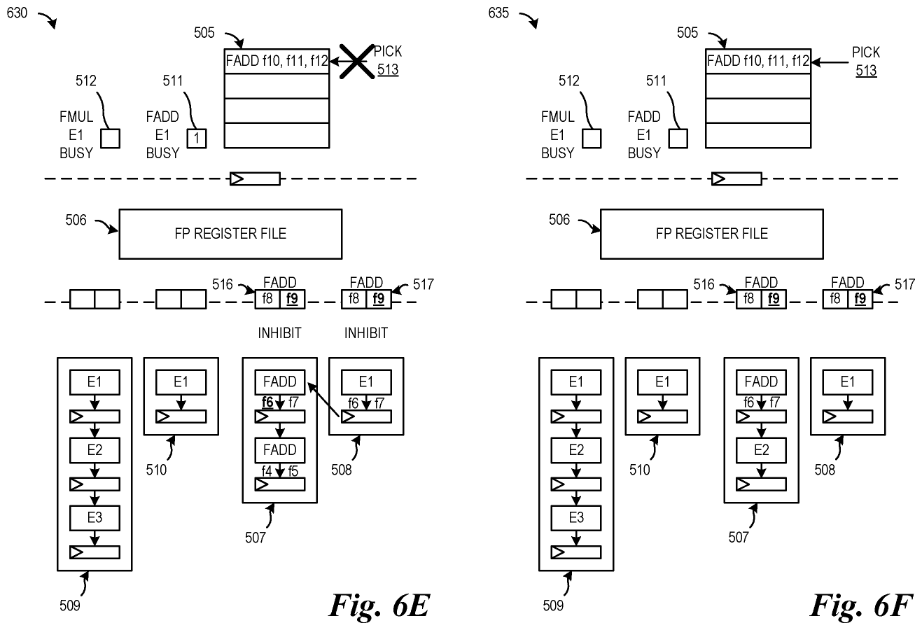

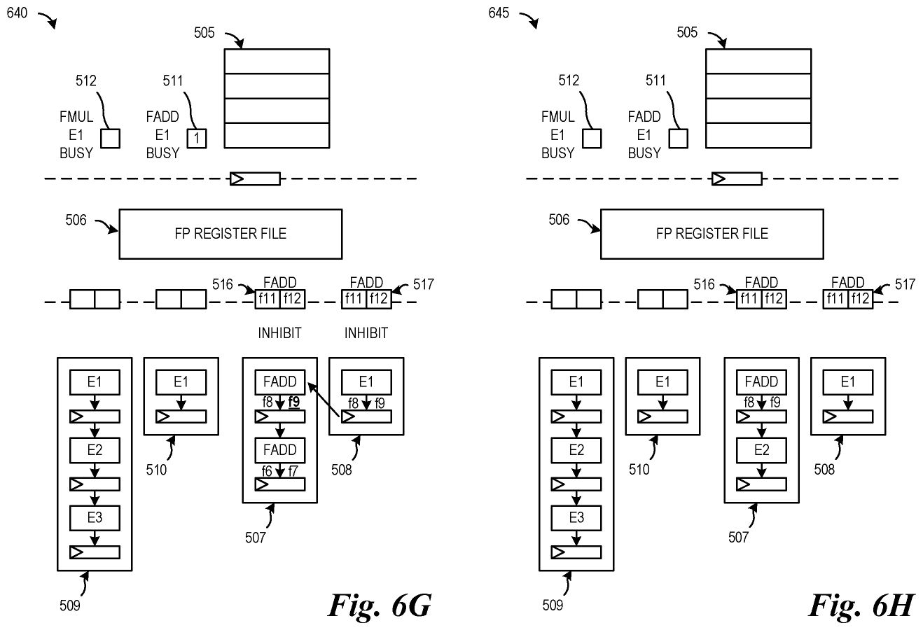

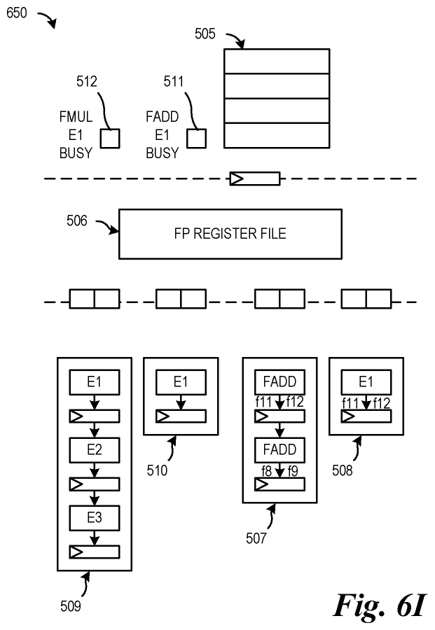

FIGS. 6A-6I illustrate a sequence of floating-point arithmetic unit block diagrams highlighting the execution of a second example sequence of floating-point instructions with some denormal operands.

FIG. 6A illustrates a first floating-point arithmetic unit block diagram 600. First floating-point arithmetic unit block diagram 600 displays a floating-point arithmetic unit were components that have similar numbers to the floating-point arithmetic unit shown in FIGS. 5A-5F have similar functionality. As shown in FIG. 6A, no floating-point instructions have been dispatched. However, pick 513 is pointing at floating-point instruction “FADD f1, f4, f5” with both operands f4 and f5 being bolded and underlined to indicate that operands f4 and f5 being denormals.

FIG. 6B illustrates a second floating-point arithmetic unit block diagram 615. Second floating-point arithmetic unit block diagram 615 displays the floating-point arithmetic unit one clock cycle after first floating-point arithmetic unit block diagram 600 shown in FIG. 6A. After one clock cycle, floating-point instruction “FADD f1, f4, f5” has been dispatched and operands have been loaded into registers 516 and 517 for loading into the first stages of floating-point add pipeline 507 and first DNU 508. Also, pick 513 has now moved to floating-point instruction “FADD f2, f6, f7” with operand f6 being denormal and operand f7 being a normal floating-point value.

FIG. 6C illustrates a third floating-point arithmetic unit block diagram 620. Third floating-point arithmetic unit block diagram 620 displays the floating-point arithmetic unit one clock cycle after second floating-point arithmetic unit block diagram 615 shown in FIG. 6B. After one clock cycle, the first stage of floating-point add pipeline 507 has processed operands f4 and f5 (although they were denormals). Also, first DNU 508 has normalized operands f4 and f5. Because operands f4 and f5 were denormals, floating-point add busy flag 511 was set to the specified value to stall issue queue 505 from issuing floating-point add operations. Furthermore, FADD E1 Busy flag 511 is set to inhibit to prevent operands f6 and f7 (stored in memories 516 and 517) from being provided to the first stages of floating-point add pipeline 507 and first DNU 508 in the next clock cycle. Instead, outputs of first DNU 508 (the normalized operands f4 and f5) are provided to the first stage of floating-point add pipeline 507. Additionally, a pipeline invalid bit from the first stage of floating-point add pipeline 507 is set to the specified value to indicate that the output of the first stage of floating-point add pipeline 507 is not valid. Pick 513 has now changed to not point to the next floating-point instruction because the next floating-point instruction is a floating-point add instruction and floating-point add busy flag 511 indicates that the next floating-point add instruction should be stalled.

FIG. 6D illustrates a fourth floating-point arithmetic unit block diagram 625. Fourth floating-point arithmetic unit block diagram 625 displays the floating-point arithmetic unit one clock cycle after third floating-point arithmetic unit block diagram 620 shown in FIG. 6C. After one clock cycle, the first stage of floating-point add pipeline 507 has processed normalized operands f4 and f5. Additionally, floating-point add busy flag 511 has been cleared so it no longer inhibit operands f6 and f7 from being provided to the first stages of floating-point add pipeline 507 and first DNU 508 in the next clock cycle. Pick 513 now indicates that floating-point instruction “FADD f3, f8, f9” with operand f8 being a normal floating-point value and operand f9 being denormal.

FIG. 6E illustrates a fifth floating-point arithmetic unit block diagram 630. Fifth floating-point arithmetic unit block diagram 630 displays floating-point arithmetic unit one clock cycle after fourth floating-point arithmetic unit block diagram 625 shown in FIG. 6D. After one clock cycle, the second stage of floating-point add pipeline 507 has processed the output of the first stage of floating-point add pipeline 507. The first stage of floating-point add pipeline 507 has processed operands f6 and f7 (although operand f6 is denormal). Because operand f6 is denormal, floating-point add busy flag 511 was set to the specified value to stall issue queue 505 from issuing floating-point add operations and inhibits operands f8 and f9 (stored in memories 516 and 517) from being provided to the first stages of floating-point add pipeline 507 and first DNU 508 in the next clock cycle. Instead, outputs of first DNU 508 (the normalized operand f6 and unaltered operand f7) are provided to the first stage of floating-point add pipeline 507. Additionally, a pipeline invalid bit from the first stage of floating-point add pipeline 507 is set to indicate that the output of the first stage of floating-point add pipeline 507 is not valid. Pick 513 has now changed to not point to the next floating-point instruction because the next floating-point instruction is a floating-point add instruction and floating-point add busy flag 511 indicates that the next floating-point add instruction should be stalled.

FIG. 6F illustrates a sixth floating-point arithmetic unit block diagram 635. Sixth floating-point arithmetic unit block diagram 635 displays floating-point arithmetic unit one clock cycle after fifth floating-point arithmetic block diagram 630 shown in FIG. 6E. After one clock cycle, the first stage of floating-point add pipeline 507 has processed the normalized operand f6 and the normal operand f7. Additionally, floating-point add busy flag 511 has been cleared and so it no longer inhibits operands f6 and f7 from being provided to the first stages of floating-point add pipeline 507 and first DNU 508 in the next clock cycle. Pick 513 has now moved to floating-point instruction “FADD f10, f11, f12” with both operands f11 and f12 being normal floating-point values.

FIG. 6G illustrates a seventh floating-point arithmetic unit block diagram 640. Seventh floating-point arithmetic unit block diagram 640 displays floating-point arithmetic unit one clock cycle after sixth floating-point arithmetic block diagram 635 shown in FIG. 6F. After one clock cycle, the first stage of floating-point add pipeline 507 has processed operands f8 and f9 (although operand f9 is denormal). Also, first DNU 508 has normalized operand f9 and left operand f8 unaltered. Because operand f9 was denormal, floating-point add busy flag 511 was set to stall issue queue 505 from issuing floating-point add operations and inhibits operands f11 and f12 (stored in memories 516 and 517) from being provided to the first stages of floating-point add pipeline 507 and first DNU 508 in the next clock cycle. Instead, outputs of first DNU 508 (the normalized operands f9 and unaltered f8) are provided to the first stage of floating-point add pipeline 507. Additionally, a pipeline invalid bit from the first stage of floating-point add pipeline 507 is set to indicate that the output of the first stage of floating-point add pipeline 507 is not valid. The second stage of floating-point add pipeline 507 processes the output of the first stage of floating-point add pipeline 507 from the previous clock cycle.

FIG. 6H illustrates an eighth floating-point arithmetic unit block diagram 645. Eighth floating-point arithmetic unit block diagram 645 displays floating-point arithmetic unit one clock cycle after seventh floating-point arithmetic block diagram 640 shown in FIG. 6G. After one clock cycle, the first stage of floating-point add pipeline 507 has processed normalized operand f9 and normal operand f8. Additionally, floating-point add busy flag 511 has been cleared and so it no longer inhibits operands f11 and f12 from being provided to the first stages of floating-point add pipeline 507 and first DNU 508 in the next clock cycle.

FIG. 6I illustrates a ninth floating-point arithmetic unit block diagram 650. Ninth floating-point arithmetic unit block diagram 650 displays floating-point arithmetic unit one clock cycle after eighth floating-point arithmetic block diagram 645 shown in FIG. 6G. After one clock cycle, the second stage of floating-point add pipeline 507 has processed the output of the first stage of floating-point add pipeline 507. The first stage of the floating-point add pipeline 507 has processed normal operands f11 and f12. Additional processing may occur in subsequent clock cycles, but are not shown herein.

According to an example embodiment, methods and apparatus are provided that enable the computation of arithmetic operations with denormal inputs in a floating-point execution pipeline of a vector floating-point arithmetic unit. A major difference between scalar floating-point arithmetic units (such as those discussed above) and vector floating-point arithmetic units is that control flow operates in lockstep fashion in the vector floating-point arithmetic units. In other words, the same processing must be provided for all of the operands of a vector.

In an embodiment, if at least one operand of the vector is detected as a denormal, then all operands must be processed by DNUs. Even if every operand of the vector is normal except for one operand, all operands are processed by DNUs. If a normal operand is processed by a DNU, then it is passed through the DNU unchanged.

In an embodiment, a vector status bit is used to block the issue for the particular instruction type in the issue queue when any operand of the vector is a denormal. When the vector status bit is set to a specified value (e.g., a binary ‘1’) then the issue queue is prevented from issuing that instruction type for all operands or elements of the vector. Alternatively, the specified value may be a binary ‘0’ to prevent the issue queue from issuing that instruction type for all operands of the vector.

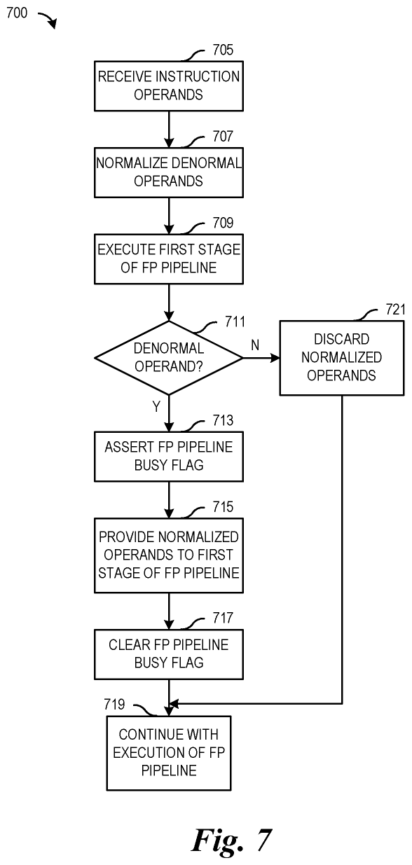

FIG. 7 illustrates a flow diagram of example operations 700 occurring in a floating-point arithmetic unit that is capable of processing denormal inputs without incurring additional latency associated with the processing of denormals. Operations 700 may be indicative of operations occurring in a floating-point arithmetic that is capable of processing denormal inputs without incurring additional latency associated with the processing of denormals in accordance with example embodiments presented herein.

Operations 700 begin with the floating-point arithmetic unit receiving operands for a floating-point instruction (block 705). As discussed previously, both a floating-point execution pipeline and an associated DNU receive the operands for the floating-point instruction. The floating-point arithmetic unit normalizes the denormal operands (block 707) and executes the first stage of the floating-point execution pipeline (block 709). As previously presented, the normalization of the denormal operands (block 707) and the execution of the first stage of the floating-point execution pipeline (block 709) occurs in parallel so that the latency associated with normalizing denormals is hidden. The normalization of the denormal operands occur in the DNU associated with the floating-point execution pipeline executing the floating-point instruction.

Floating-point arithmetic unit performs a check to determine if any of the operands is denormal (block 711). If at least one of the operands is denormal, floating-point arithmetic unit asserts a flag (or status bit) to indicate that the floating-point execution pipeline is busy (block 713). The assertion of the flag (or status bit) stalls the dispatch of any subsequent floating-point instruction of the same type. Floating-point arithmetic unit provides the normalized operands (as well as the normal operands) to the first stage of the floating-point execution pipeline (block 715). Floating-point arithmetic unit clears the flag (or status bit) (block 717) and the operation of the floating-point execution pipeline continues (block 719). As an example, if subsequent stages of the floating-point execution pipeline are ready to execute, they are allowed to complete.

If none of the operands are denormal (block 711), the floating-point arithmetic unit discards the normalized operands produced by the DNU.

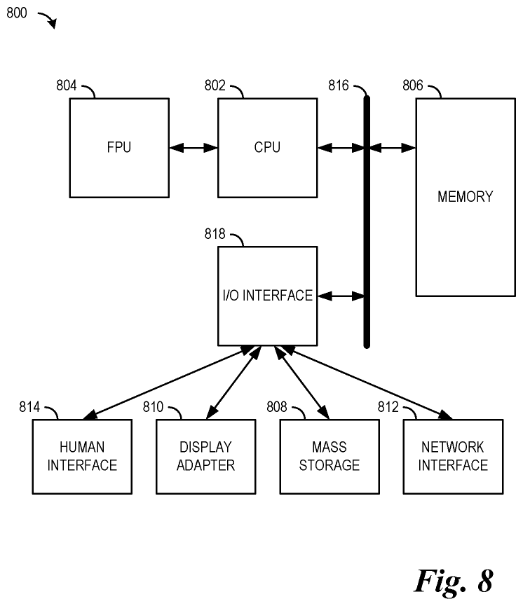

FIG. 8 illustrates a block diagram of a computing system 800 that may include the methods and apparatus disclosed herein. For example, computing system 800 may include a floating-point arithmetic unit that is capable of processing denormal inputs without incurring additional latency associated with the processing of denormals. The floating-point arithmetic unit may be a scalar floating-point arithmetic unit or a vector floating-point arithmetic unit.

Specific computing systems may utilize all of the components shown or only a subset of the components, and levels of integration may vary from device to device. Furthermore, a computing system may contain multiple instances of a component, such as multiple processing units, processors, memories, transmitters, receivers, etc. The computing system 800 includes a processing unit (CPU) 802, a floating-point arithmetic unit (FPU) 804, memory 806, and may further include mass storage 808, a display adapter 810, a network interface 812, human interface 814. Mass storage 808, display adapter 810, network interface 812, and human interface 814 may be connected to a bus 816 or through an I/O interface 818 connected to bus 816.

Mass storage 808 may comprise any type of non-transitory storage device configured to store data, programs, and other information and to make the data, programs, and other information accessible via bus 816. Mass storage 808 may comprise, for example, one or more of a solid state drive, hard disk drive, a magnetic disk drive, or an optical disk drive.

Display adapter 810 and I/O interface 818 provide interfaces to couple external input and output devices to the CPU 802. As illustrated, examples of input and output devices include a display coupled the video adapter 810 and a mouse, keyboard, or printer coupled to human interface 814. Other devices may be coupled to CPU 802, and additional or fewer interface cards may be utilized. For example, a serial interface such as Universal Serial Bus (USB) (not shown) may be used to provide an interface for an external device.

Computing system 800 also includes one or more network interfaces 812, which may comprise wired links, such as an Ethernet cable, or wireless links to access nodes or different networks. Network interfaces 812 allow computing system 800 to communicate with remote units via the networks. For example, network interfaces 812 may provide wireless communication via one or more transmitters/transmit antennas and one or more receivers/receive antennas. In an embodiment, computing system 800 is coupled to a local-area network or a wide-area network for data processing and communications with remote devices, such as other processing units, the Internet, or remote storage facilities.

FPU 804 includes one or more floating-point execution pipelines, and for each floating-point execution pipeline, there is an associated DNU configured to normalize denormals in parallel with the floating-point execution pipeline. FPU 804 also includes a denormalize unit coupled to the outputs of the floating-point execution pipelines. The denormalize unit denormalizes floating-point values as needed prior to the floating-point values being fedback to a floating-point register file or a floating-point store. An example FPU 804 is shown in FIG. 4.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by an executing unit or module, an executing unit or module, a detecting unit or module, an asserting unit or module, a providing unit or module, a converting unit or module, or a normalizing unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of the disclosure as defined by the appended claims.

What is claimed is:

1. A floating-point (FP) arithmetic unit comprising:
a first FP execution pipeline operatively coupled to a register file and an instruction dispatch, the first FP execution pipeline configured to:
perform a first FP operation on a first FP operand provided by the register file, the first FP execution pipeline comprising a first plurality of execution units; and
a first normalization unit operatively coupled to the register file, the first FP execution pipeline, and the instruction dispatch, the first normalization unit configured to:
normalize the first FP operand provided by the register file,
wherein the first normalization unit is configured to:
operate in parallel with the first FP execution pipeline,
in response to detecting that the first FP operand is a denormal:
assert a first FP execution pipeline busy flag to stall the instruction dispatch of a first subsequent FP operation, and
provide the normalized first FP operand to the first FP execution pipeline, the first FP operation and the first subsequent FP operation being of a first FP operation type.

2. The FP arithmetic unit of claim 1, wherein the first FP execution pipeline is further configured to:
perform a second FP operation on a second FP operand provided by the register file, wherein the first normalization unit is further configured to:
normalize the second FP operand provided by the register file, and
in response to detecting that the second FP operand is normal, discard the normalized second FP operand.

3. The FP arithmetic unit of claim 1, wherein the FP execution pipeline comprises one of a FP addition execution pipeline, a FP multiplication pipeline, an FP division pipeline, an FP square-root or generalized root pipeline, an FP exponential pipeline, an FP power pipeline, or an FP logarithm pipeline, or any other operation or instruction on a floating-point operand.

4. The FP arithmetic unit of claim 1, further comprising:
a second FP execution pipeline operatively coupled to the register file and the instruction dispatch, the second FP execution pipeline configured to:
perform a third FP operation on a third FP operand provided by the register file, the second FP execution pipeline comprising a second plurality of execution units; and
a second normalization unit operatively coupled to the register file, the second FP execution pipeline, and the instruction dispatch, the second normalization unit configured to:
normalize the third FP operand provided by the register file,
wherein the second normalization unit is configured to:
operate in parallel with the second FP execution pipeline,
in response to detecting that the third FP operand is a denormal:
assert a second FP execution pipeline busy flag to stall the instruction dispatch of a second subsequent FP operation, and
provide the normalized third FP operand to the second FP execution pipeline, the third FP operation and the second subsequent FP operation being of a second FP operation type.

5. The FP arithmetic unit of claim 4, wherein the second FP execution pipeline is further configured to perform a fourth FP operation on a fourth FP operand provided by the register file, wherein the second normalization unit is further configured to:
normalize the fourth FP operand provided by the register file, and
in response to detecting that the fourth FP operand is a normal, discard the normalized fourth FP operand.

6. The FP arithmetic unit of claim 4, wherein the first normalization unit is further configured to:
cause the second normalization unit to assert the second FP execution pipeline busy flag, and
provide the normalized third FP operand to the second FP execution pipeline when asserting the first FP execution pipeline busy flag, and wherein the second normalization unit is further configured to:
cause the first normalization unit to assert the first FP execution pipeline busy flag, and
provide the normalized first FP operand to the first FP execution pipeline when asserting the second FP execution pipeline busy flag.

7. The FP arithmetic unit of claim 1, further comprising a denormal unit operatively coupled to the first FP execution pipeline, the denormal unit configured to:
convert a fifth FP operand outputted by the first FP execution pipeline into a denormal.

8. A system comprising:
a non-transitory memory storage comprising instructions and data;
one or more processors in communication with the non-transitory memory storage, wherein the one or more processors execute the instructions; and
a floating-point (FP) arithmetic unit in communication with the one or more processors and the non-transitory memory storage, the FP arithmetic unit comprising:
a first FP execution pipeline operatively coupled to a register file and an instruction dispatch, the first FP execution pipeline configured to:
perform a first FP operation on a first FP operand provided by the register file, the first FP execution pipeline comprising a first plurality of execution units; and
a first normalization unit operatively coupled to the register file, the first FP execution pipeline, and the instruction dispatch, the first normalization unit configured to:
normalize the first FP operand provided by the register file,
wherein the first normalization unit is configured to:
operate in parallel with the first FP execution pipeline, and
in response to detecting that the first FP operand is a denormal:
assert a first FP execution pipeline busy flag to stall the instruction dispatch of a first subsequent FP operation, and
provide the normalized first FP operand to the first FP execution pipeline, the first FP operation and the first subsequent FP operation being of a first FP operation type.

9. The system of claim 8, wherein the first FP execution pipeline is further configured to:
perform a second FP operation on a second FP operand provided by the register file, wherein the first normalization unit is further configured to:
normalize the second FP operand provided by the register file, and
in response to detecting that the second FP operand is a normal, discard the normalized second FP operand.

10. The system of claim 8, wherein the FP execution pipeline comprises one of a FP addition execution pipeline, a FP multiplication pipeline, an FP division pipeline, an FP square-root or generalized root pipeline, an FP exponential pipeline, an FP power pipeline, or an FP logarithm pipeline, or any other operation or instruction on a floating-point operand.

11. The system of claim 8, further comprising:
a second FP execution pipeline operatively coupled to the register file and the instruction dispatch, the second FP execution pipeline configured to:
perform a third FP operation on a third FP operand provided by the register file, the second FP execution pipeline comprising a second plurality of execution units; and
a second normalization unit operatively coupled to the register file, the second FP execution pipeline, and the instruction dispatch, the second normalization unit configured to:
normalize the third FP operand provided by the register file,
wherein the second normalization unit is configured to:
operate in parallel with the second FP execution pipeline, and
in response to detecting that the third FP operand is a denormal:
assert a second FP execution pipeline busy flag to stall the instruction dispatch of a second subsequent FP operation, and
provide the normalized third FP operand to the second FP execution pipeline, the third FP operation and the second subsequent FP operation being of a second FP operation type.

12. The system of claim 11, wherein the second FP execution pipeline is further configured to:
perform a fourth FP operation on a fourth FP operand provided by the register file, wherein the second normalization unit is further configured to:
normalize the fourth FP operand provided by the register file, and
in response to detecting that the fourth FP operand is a normal, discard the normalized fourth FP operand.

13. The system of claim 11, wherein the first normalization unit is further configured to:
cause the second normalization unit to assert the second FP execution pipeline busy flag, and
provide the normalized third FP operand to the second FP execution pipeline when asserting the first FP execution pipeline busy flag, and wherein the second normalization unit is further configured to:
cause the first normalization unit to assert the first FP execution pipeline busy flag. and
provide the normalized first FP operand to the first FP execution pipeline when asserting the second FP execution pipeline busy flag.

14. The system of claim 8, further comprising a denormal unit operatively coupled to the first FP execution pipeline, the denormal unit configured to:
convert a fifth FP operand outputted by the first FP execution pipeline into a denormal.

15. A method implemented by a floating-point (FP) arithmetic unit comprising:
receiving, by the FP arithmetic unit, from an instruction dispatch, a first FP operation and a first FP operand;
executing, by a first FP execution pipeline of the FP arithmetic unit, the first FP operation with the first FP operand;
normalizing, by a first normalization unit of the FP arithmetic unit, the first FP operand in parallel with the executing of the first FP operation; and
in response to detecting, by the first normalization unit of the FP arithmetic unit, that the first FP operand is a denormal:
asserting, by the first normalization unit of the FP arithmetic unit, a first FP execution pipeline busy flag to stall the instruction dispatch of a first subsequent FP operation, the first FP operation and the first subsequent FP operation being of a first FP operation type; and
providing, by the first normalization unit of the FP arithmetic unit, the normalized first FP operand to the first FP execution pipeline.

16. The method of claim 15, further comprising:
receiving, by the FP arithmetic unit, from the instruction dispatch, a second FP operation and a second FP operand;
executing, by the first FP execution pipeline of the FP arithmetic unit, the second FP operation with the second FP operand;
normalizing, by the first normalization unit of the FP arithmetic unit, the second FP operand in parallel with the executing of the second FP operation; and
in response to detecting, by the first normalization unit of the FP arithmetic unit, that the first FP operand is a normal, discarding the normalized second FP operand.

17. The method of claim 16, further comprising:
receiving, by the FP arithmetic unit, from the instruction dispatch, a third FP operation and a third FP operand;
executing, by a second FP execution pipeline of the FP arithmetic unit, the third FP operation with the third FP operand;
normalizing, by a second normalization unit of the FP arithmetic unit, the third FP operand in parallel with the executing of the third FP operation; and
in response to detecting, by the second normalization unit of the FP arithmetic unit, that the third FP operand is a denormal:
asserting, by the second normalization unit of the FP arithmetic unit, a second FP execution pipeline busy flag to stall the instruction dispatch of a second subsequent FP operation, the third FP operation and the second subsequent FP operation being of a second FP operation type; and
providing, by the second normalization unit of the FP arithmetic unit, the normalized second FP operand to the second FP execution pipeline.

18. The method of claim 17, further comprising:
receiving, by the FP arithmetic unit, from the instruction dispatch, a fourth FP operation and a fourth FP operand;
executing, by the second FP execution pipeline of the FP arithmetic unit, the fourth FP operation with the fourth FP operand;
normalizing, by the second normalization unit of the FP arithmetic unit, the fourth FP operand in parallel with the executing of the fourth FP operation; and
in response to detecting, by the second normalization unit of the FP arithmetic unit, that the fourth FP operand is a normal, discarding the normalized fourth FP operand.

19. The method of claim 17, further comprising, when detecting that the first FP operand is a denormal:
asserting, by the second normalization unit of the FP arithmetic unit, the second FP execution pipeline busy flag to stall the instruction dispatch of a subsequent FP operating having a same FP operation type as the third FP operation; and
providing, by the second normalization unit of the FP arithmetic unit, the normalized second FP operand to the second FP execution pipeline.

20. The method of claim 15, further comprising converting, by a denormal unit of the FP arithmetic unit, a sixth FP operand outputted by the first FP execution pipeline to a denormal FP number unit.

21. The method of claim 15, the first FP operation comprising one of a FP addition operation or a FP multiplication operation.

22. The method of claim 15, the first subsequent FP operation and the first FP operation are of a same FP operation type.
